(19) United States
(12) Patent Application Publication
(10) Pub. No.: US 2011/0157083 A1
(43) Pub. Date: Jun. 30, 2011

(54) RESISTIVE TOUCH APPARATUS

(75) Inventors: Ziv HERSHMAN, Givat-Shmuel (IL); Boaz TABACHNIK, Moshav Gimzo (IL); Andrey TOVCHIGRECHKO, Moscow (RU)

(73) Assignee: NUVOTON TECHNOLOGY CORPORATION, Taiwan (TW)

(21) Appl. No.: 12/979,384

(22) Filed: Dec. 28, 2010

Related U.S. Application Data
(60) Provisional application No. 61/291,388, filed on Dec. 31, 2009.

(51) Int. Cl. G06F 3/045; G06F 15/18

(52) U.S. Cl. 345/174; 706/12

(57) ABSTRACT

The subject matter discloses an apparatus, comprising a first resistive sheet and a second resistive sheet disposed in proximity to the first resistive sheet, such that pressure applied at a first touch point and at a second touch point on the first resistive sheet causes flow of electrical current between the first resistive sheet and the second resistive sheet. The apparatus further comprises a control unit coupled to a first terminal and to a second terminal, and configured to measure a first resistance between the first terminal and the second terminal; and configured to estimate a distance between the first touch point and the second touch point. The apparatus further estimates the location of the first touch point and the second touch point.

This application claims priority from provisional application No. 61/291,388 filed Dec. 31, 2009.

### FIELD OF THE INVENTION

The subject matter relates generally to resistive touch apparatuses, and more specifically to a method and apparatus for detecting the positions of two touch points on a surface of a resistive touch pad.

### BACKGROUND OF THE INVENTION

Resistive touch apparatuses are typically composed of two resistive sheets, both coated with a resistive material and separated by a thin layer of either air or microdots. The outer sheet, also referred to as the first resistive sheet, is made of a flexible material, and can be physically touched by the user's finger or stylus-type tool. The second resistive sheet, which is the inner sheet, is made of a rigid material. When the first resistive sheet is touched, it is pressed against the second resistive sheet and contact between the two resistive sheets is made.

Resistive touch apparatuses may be used for resistive touch screens or any device that enables a user to perform any action by touching a portion of the device where the resistive sheet is positioned.

Currently available four-wire resistive touch apparatuses determine the location of one point of touch. The X coordinate is extracted from measuring one resistive sheet and the Y coordinate is extracted from measuring the other resistive sheet.

### SUMMARY

The disclosed subject matter is described below with reference to flowchart illustrations and/or block diagrams of methods, apparatus (systems) and computer program products according to embodiments of the subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions, which execute on the computer or other programmable apparatus, provide processes for implementing the functions/acts specified in the flowchart and/or block diagram block or blocks.

One technical challenge disclosed in the subject matter is to detect the location of two touch points on a resistive touch panel located in an electrical or computerized device. Detecting the location of two touch points is used, for example, when a person applies two fingers or stylus-type tools to perform actions associated with the resistive touch apparatus. Examples of such actions are: manipulating the image displayed on the device, selecting a menu item, grabbing an object, rotating an object, enlarging an object size, and the like.

One technical solution of the disclosed subject matter is to estimate the distance between the two touch points on the X-axis (DX) and/or the distance between the two touch points on the Y-axis (DY). This distance may also refer to the distance between the two touch points on the X-axis or on the Y-axis. Such a resistive touch apparatus can be embedded in an electronic device as a touch screen or as a portion of an interface, allowing a user to perform an action using touch, for example, by touching it with his fingers.

The technical solution disclosed above comprises a method and a resistive touch apparatus in which measurements are performed and the measured data is used to estimate the distance between the two touch points and/or the location of the two touch points. The method comprises at least, a portion of the following, for example, evaluating the equivalent resistance or voltage between at least two terminals. Such an evaluation may be performed, for example, by measuring the current through at least one terminal and by measuring the voltage difference between at least two terminals. The voltage can be measured using an analog-to-digital converter (ADC) and the current can be extracted, for example, from measuring the voltage on a serial resistor with a known value. The serial resistor may be placed between a voltage source and a terminal.

Some of the measurements provided in the disclosed subject matter are: resistance values between at least two terminals connected to the same resistive sheet, also referred to as sheet resistance, and resistance values between terminals connected to different sheets, also referred to as inter-sheet resistance.

The resistive touch apparatus and method enable applying electronic attributes such as current, voltage value and resistance value on at least some terminals of a first resistive sheet and/or a second resistive sheet, and, conversely, obtaining similar electronic attributes from at least one of the terminals. Such electronic attributes may be obtained by applying different voltage values on at least part of the terminals or by applying different currents through at least part of the terminals and measuring electrical attributes of terminals of the resistive touch apparatus. A control unit of the disclosed apparatus may apply such voltage values.

The method may also disclose obtaining a computational model that represents the relation between the distance between the touch points and/or the locations of the touch points, and the obtained electronic attributes. The method may use a learning process of the characteristics of a resistive touch panel within the resistive touch apparatus. Such resistive touch panel comprises the first resistive sheet, the second resistive sheet and terminals. The model may use measurements of various touch points on the resistive touch panel. The learning process may include touching the first resistive sheet with different intensities and locations. Touch intensity may refer to a combination that includes the touch point size, the touch point shape and the force used when pressing the touch point.

The method may also include periodic calibration of the resistive touch apparatus. The periodic calibration may be applied when no touch is detected, for example, by measuring the resistance value between at least two terminals of the first and/or second resistive sheet.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are optionally designated by the same numerals or letters.

FIG. 1 shows a resistive touch apparatus, according to some exemplary embodiments of the disclosed subject matter;

FIG. 2 shows voltage measurements, according to exemplary embodiments of the disclosed subject matter;

FIG. 3 shows sheet resistance measurements, for measuring resistance values between terminals of a single resistive sheet, according to exemplary embodiments of the disclosed subject matter;

FIG. 4 shows inter-sheet resistance measurements for measuring resistance values between terminals of the two resistive sheets, according to exemplary embodiments of the disclosed subject matter;

FIG. 5 shows quadruple inter-sheet resistance measurements, according to exemplary embodiments of the disclosed subject matter;

FIG. 6 shows a control unit of a resistive touch apparatus, according to some exemplary embodiments of the disclosed subject matter;

FIG. 7 shows a method for determining the location of two touch points on a resistive sheet, according to some exemplary embodiments of the disclosed subject matter;

FIG. 8 shows a method for determining a touch state on a first resistive sheet, according to some exemplary embodiments of the disclosed subject matter;

FIG. 9 shows a lookup table that stores electronic attributes measured during the resistive touch apparatus learning process, according to exemplary embodiments of the disclosed subject matter;

FIG. 10 shows a first resistive sheet touched at two points, according to exemplary embodiments of the disclosed subject matter; and;

FIG. 11 shows a simplified resistance model of a first and second resistive sheets when the first sheet is touched at two points, according to exemplary embodiments of the disclosed subject matter.

### DETAILED DESCRIPTION

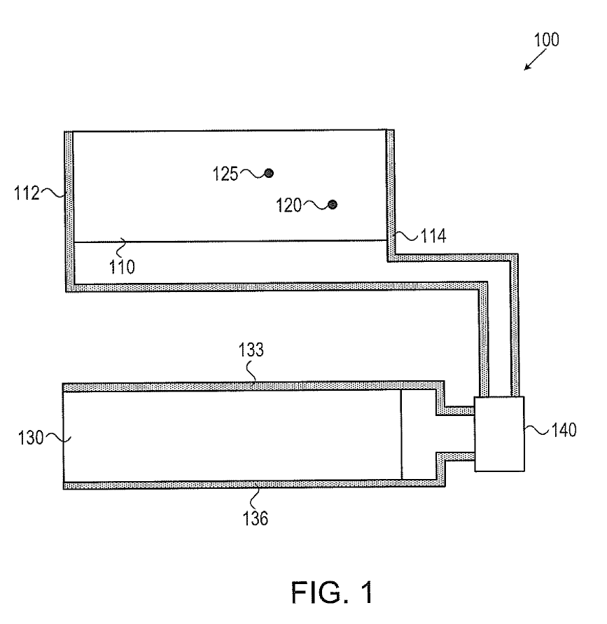

FIG. 1 shows a resistive touch apparatus, according to some exemplary embodiments of the subject matter. The resistive touch apparatus 100 comprises a first resistive sheet 110, which the user presses to perform an action, and a second resistive sheet 130. When the first resistive sheet 110 is pressed, contact is made with the second resistive sheet 130 at the location of the touch point or touch points.

The first resistive sheet 110 and the second resistive sheet 130 may be rectangular, elliptical, polygonal or a combination thereof. In some exemplary embodiments, the first resistive sheet and the second resistive sheet are at least a portion of a touch screen associated with a computerized device. The resistive touch apparatus 100 may be implemented in display devices, phones, cellular phones, personal computers, tablet PCs, PDAs, electronic books, personal navigation devices and any other electronic device operated by a user.

The resistive touch apparatus 100 disclosed in some embodiments of the subject matter is a four-wire resistive touch apparatus. Other resistive touch apparatuses may also utilize the apparatus and methods of the subject matter, such as a five-wire resistive touch apparatus or other resistive touch apparatus having four or more terminals.

The resistive touch apparatus 100 comprises terminals positioned on edges of each sheet. The term edge may refer to at least a portion of a side of a sheet, a corner of a sheet or a combination thereof. Such terminals, for example, terminal 112, may be connected to a control unit 140. The control unit 140 may apply or control currents and voltage values of terminals, such as the terminal 112.

In an exemplary embodiment of resistive touch apparatus 100, the first resistive sheet 110 is touched simultaneously at a first point 120 and at a second point 125. The control unit 140 of the resistive touch apparatus 100 determines the distance between and/or the location of the first point 120 and the second point 125.

In the exemplary embodiment in which the resistive touch apparatus is a four-wire apparatus, the first resistive sheet 110 is connected to terminals 112, 114, located on the left and right edges of the first resistive sheet 110. Similarly, the second resistive sheet 130 is connected to terminals 133, 136 located on the top and bottom edges of the second resistive sheet 130.

In some exemplary embodiments of the subject matter, the terminals 112, 114, 133, 136 may be connected to an electronic appliance such that an electronic measurable attribute can be obtained from the terminals 112, 114, 133, 136. The electronic attributes of the terminals 112, 114, 133, 136 enable determining the location of the first point 120 and the second point 125, as described below.

The resistive touch apparatus 100 comprises a control unit 140 for applying electronic attributes on the terminals 112, 114, 133, 136, for obtaining electronic attributes from the terminals and for performing manipulations on the information detected from the terminals. The control unit 140 may be configured to estimate a distance between the two touch points on the X-axis or on the Y-axis of the first resistive sheet according to electronic attributes detected by a voltage measurement module or a resistance measurement module. The control unit 140 may also be configured to estimate the location of the two touch points.

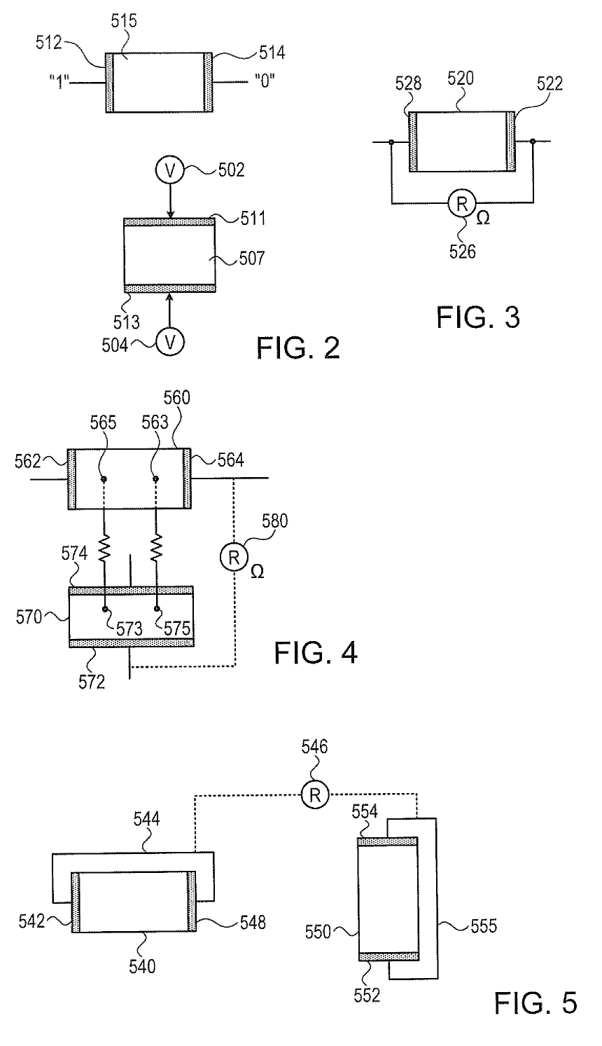

FIG. 2 shows voltage measurements according to exemplary embodiments of the disclosed subject matter. The voltage measurements utilize terminals 512, 514 connected to the first resistive sheet 515, and terminals 511, 513 connected to the second resistive sheet 507. The terminals 512, 514 are provided with different predefined voltage values by the control unit. The voltage values may be provided to terminal 512 and to terminal 514 by the control unit (not shown). When voltage is applied at terminals 512, 514, the voltage on the terminals 511, 513 is measured. The voltage measurements on the terminals 511, 513 may be performed by voltage measurement modules 502, 504. A voltage measurement module may comprise an ADC. Such voltage measurements may be used, for example, to detect the middle point of the two touch points or the angle between a virtual line that connects the two touch points and the X-axis or Y-axis of the resistive sheet.

In some cases, when the control unit applies a higher voltage on the terminal 512 and a lower voltage on the terminal 514, the voltage value on the terminal 511 is referred to as measurement setup 1 (MS1) and the voltage value in the terminal 513 is referred to as measurement setup 2 (MS2). In some exemplary cases, an ADC is used to measure the voltage on the terminals 511, 513. Similarly, when applying a voltage value to the terminal 511 that is higher than the voltage applied on the terminal 513, the voltage value on the terminal 512 is referred to as MS3 and the voltage value on the terminal 514 is referred to as MS4.

FIG. 3 shows sheet resistance measurements, according to exemplary embodiments of the disclosed subject matter. The sheet resistance measurements provides for measuring the resistance value between terminals 522, 528 of the same resistive sheet 520. The two terminals 522, 528 may be positioned on opposite sides of the resistive sheet 520, as in a four-wire resistive touch panel, or on any combination of edges of the same sheet as, for example, in a five-wire sheet (not shown). The resistance measurements of FIGS. 3-5 may include a resistance measurement module (such as 526 of FIG. 3) for measuring resistance value between two or more terminals. Measuring resistance values may be performed by setting voltage difference on the measured terminals and measuring current through the measured terminals or by applying current through the measured terminals and measuring the voltage difference between the measured terminals. The measured resistance may also refer to the ratio between two or more measured resistance values. The resistance value detected by the resistance measurement module 526 may be obtained by the control unit. The sheet resistance measurements enable measuring resistance value between terminals of a single sheet. In a four-wire resistive touch apparatus, such measurement may be performed on terminals of the first resistive sheet, referred to as MS5, and on the terminals of the second resistive sheet, referred to as MS6. In a five-wire resistive touch apparatus, resistance value measurements are performed between different permutations of terminals positioned on the same sheet. This enables the generation of voltage gradients at different directions across the resistive sheet. Applying voltage gradients in more than two directions may enable gathering more information about the touch points and therefore may enable more accurate detection of touch point locations.

FIG. 4 shows inter-sheet resistance measurements, according to exemplary embodiments of the disclosed subject matter. The inter-sheet resistance measurements involving terminals of different sheets, i.e., the first resistive sheet 560 and the second resistive sheet 570. Touch points 563, 565 on the first resistive sheet 560 have equivalent touch points 573, 575 on the second resistive sheet 570. In some cases, the inter-sheet resistance measurements enable measuring the resistance value between one terminal connected to the first resistive sheet and another terminal connected to the second resistive sheet. for example, measuring the resistance value between one of terminals 564, 562 of the first resistive sheet 560 and one of terminals 572, 574 of the second resistive sheet 570. Measuring the resistance value may be performed by a resistance measurement module 580, as disclosed above. It should be noted that other options to evaluate the resistance value between the two sheets may include measuring resistance value between, current through and/or voltage between two or more terminals, while at least one terminal from each sheet is connected to a resistance measurement module (such as 526 of FIG. 3). An example of this is shown in FIG. 5.

For simplicity, a person skilled in the art may refer to the resistance value between terminal 562 and terminal 572 as measurement setup 7 (MS7); to the resistance value between terminal 562 and terminal 574 as measurement setup 8 (MS8); to the resistance value between terminal 564 and terminal 572 as measurement setup 9 (MS9); and to the resistance value between terminal 564 and terminal 574 as measurement setup 10 (MS10).

FIG. 5 shows quadruple inter-sheet resistance measurements, according to exemplary embodiments of the disclosed subject matter. The quadruple inter-sheet resistance measurements enables measuring resistance between two pairs of terminals, where each pair of terminals is connected to a single sheet, such as first resistive sheet 540 and second resistive sheet 550. Each pair of terminals is connected via a conductive wire. For example, the first pair of terminals 542 and 548 is connected via conductive wire 544 and the second pair of terminals 552 and 554 is connected via conductive wire 555. Conductive wires 555 and 544 are connected to a resistance measuring module 546 for measuring the resistance value between the different sheets via conductive wires 544 and 555.

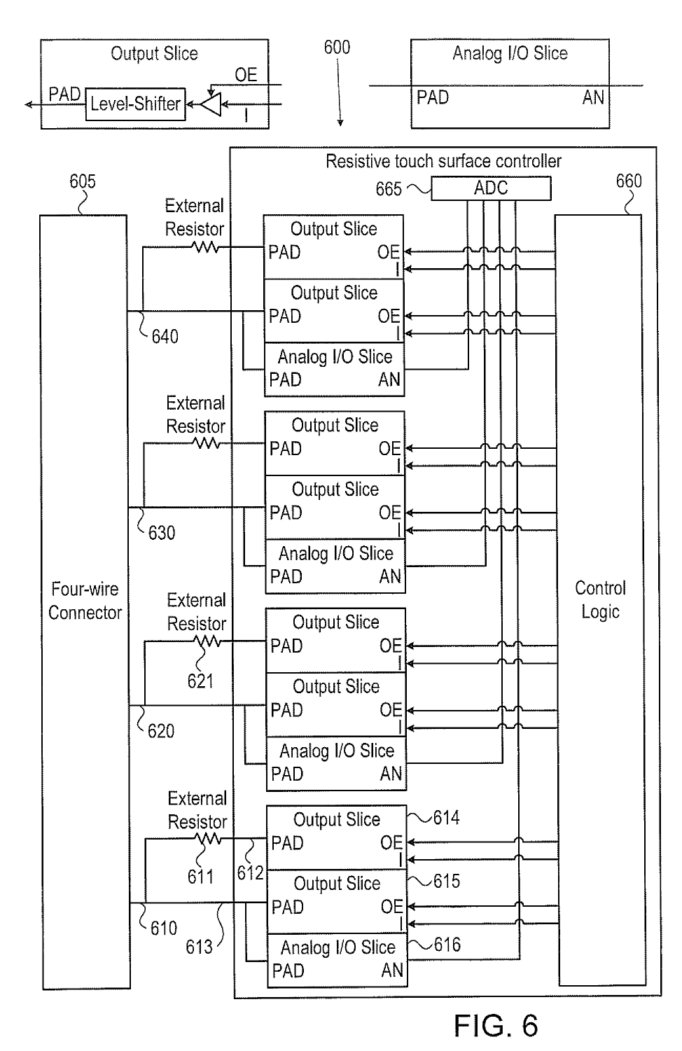

FIG. 6 shows a control unit of a resistive touch apparatus, according to some exemplary embodiments of the disclosed subject matter. The control unit may comprise an analog-to-digital converter (ADC), switches and one or more resistors. The control unit 600 is connected to terminals 610, 620, 630, 640. Each of the terminals 610, 620, 630, 640 may be connected to the first or second resistive sheets. Each of the four terminals 610, 620, 630, 640 may be connected to two controller pins, one through a resistor, and the other directly to the controller pins. For example, terminal 610 is connected to controller I/O slice 614 via a resistor 611 to controller I/O slice 615 in a direct manner and to an analog I/O slice 616 that is internally connected to the ADC. Terminals 620, 630, 640 are connected to the corresponding controller pins in a similar way. In some exemplary cases, the control unit 600 may comprise internal silicon resistors and ADC connections so that only one controller pin is required for each terminal. In such cases, a calibration mechanism for those resistors may be required due to the low accuracy of silicon resistors. Control logic 660 and ADC components 665 may be used to implement the measurements setups, as described above. In some exemplary cases, the control unit 600 may integrate a processing unit or may transmit the measurements to another module for further processing.

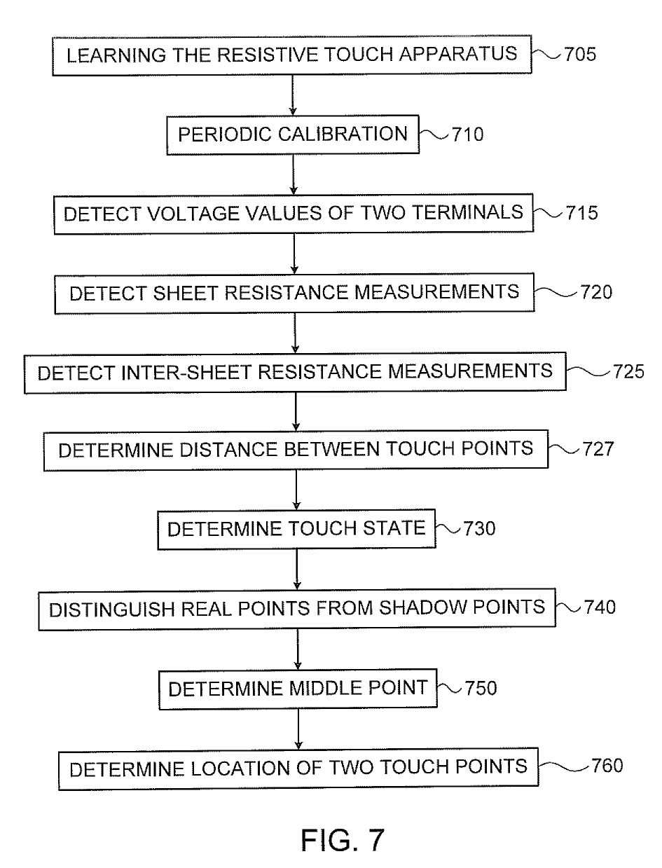

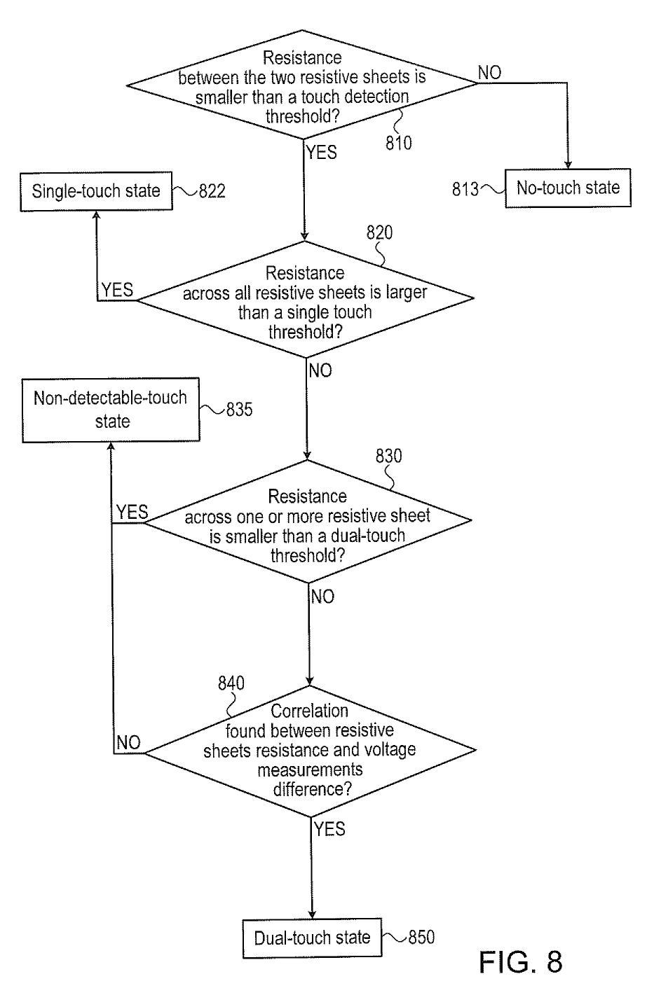

FIG. 7 shows a method for determining location of two touch points on a first resistive sheet, according to some exemplary embodiments of the disclosed subject matter.

In step 705, the resistive touch apparatus is learned. The learning process may involve a set of measurements in which two touch points on the first resistive sheet are pressed several times with a predefined intensity similar to typical fingers at predefined locations with different distances between the touch points along either the X-axis or the Y-axis of the first resistive sheet. Then, sheet resistance measurements and inter-sheet resistance measurements are performed and the relation between the measurements, the distance between the touch objects and the touch points intensity is learned and stored. This learning process may be repeated for two touch objects of with intensity similar to a stylus-type tool. In some cases, additional intensities may be learned and stored to increase accuracy. The same procedure is then performed for the other axis. The learning process results may be stored in a storage unit connected to or comprised in the resistive touch apparatus. The learning process results may be organized, for example, as one or more lookup tables, according to exemplary embodiments of the disclosed subject matter.

In step 710, a periodic calibration is made to compensate for changes in the electronic attributes related to components of the resistive touch apparatus. Such electronic attributes may include resistance of the first and second resistive sheets, resistance of other components, deviation of current sources and voltage sources, ADC measurement offset and the like. The compensated changes may result from, for example, temperature changes. When the first resistive sheet is not touched, the sheet resistance measurements, for example, MS5 and MS6, may be stored and later used as a reference for other measurements performed when the first resistive sheet is touched.

In step 715, the control unit detects voltage values of terminals of the resistive touch apparatus. In a four-wire resistive touch apparatus, the control unit applies different voltage values on two terminals connected to one resistive sheet (either the first resistive sheet or the second resistive sheet) and voltage values are measured from two terminals of the other sheet. For example, the terminals of the first resistive sheet are applied with voltage and voltage value is measured from the terminals of the second resistive sheet.

In step 720, the control unit detects resistance values between terminals of the same resistive sheet of the resistive touch apparatus. The two terminals may be positioned in opposite edges of the resistive sheet, in adjacent edges of the resistive sheet or in any other configuration. The number and the location of the terminals on the same resistive sheet may be a function of the type of the resistive touch apparatus, for example, whether the apparatus is a four-wire or five-wire apparatus.

In step 725, the control unit detects resistance values between terminals of the resistive touch apparatus, of which at least one terminal is connected to the first resistive sheet and at least another terminal is connected to the second resistive sheet. For example, such detection refers to a case in which one terminal is connected to the first resistive sheet and the second terminal is connected to the second resistive sheet. In some cases, a quadruple inter-sheet measurement may be used to detect resistance value between more than two terminals connected to different sheets. A person skilled in the art may also use other resistance measurements.

When sheet resistance measurements and inter-sheet resistance measurements are taken from a five-wire resistive touch panel, sheet resistance measurements may be taken from two pairs of opposite terminals of the same sheet. One pair includes two terminals on the X-axis and the other pair includes two terminals on the Y-axis. Alternatively, sheet resistance measurements may be taken by connecting each of the two pairs of terminals to a conductive wire and measuring the resistance value between the conductive wires associated with each of the pairs. Inter-sheet resistance measurement may be taken by measuring the resistance value between at least one terminal of the first resistive sheet and a terminal of the second resistive sheet.

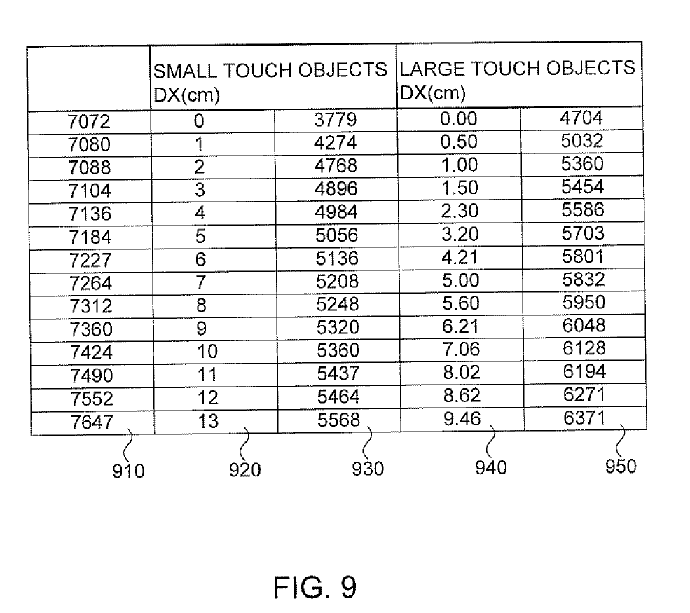

In step 727, the distance between the two touch points on the X-axis and the distance between the touch points on the Y-axis is determined. Such distances on the Y-axis and on the X-axis may be extracted from the sheet resistance measurements and inter-sheet resistance measurements. The conversion from resistance measurements into distances on the Y-axis and on the X-axis may be performed using a look-up table (such as table 900 of FIG. 9). In some cases, voltage measurements may also be used to determine distances on the Y-axis and on the X-axis.

In step 730, the touch state on the first resistive sheet is determined. Step 730 utilizes inter-sheet resistance measurement to distinguish between no-touch state and other touch states. Distinguishing between single-touch state, dual-touch state and non-detectable touch state is described in FIG. 8.

In step 740, shadow touch points are distinguished from real touch points, that is, the touch points on the first resistive sheet that were actually touched. Step 740 includes determining the range of the angle between the line connecting the two touch points and an X-axis or Y-axis of the first resistive sheet. The angle is in a range of either 0-90 degrees or 90-180 degrees. Such a range may be determined according to voltage measurements as taken in step 715.

In step 750, the location of the middle point, which represents the average of X coordinates and Y coordinates of the two touch points, is determined. The location of the middle point may be determined using the voltage measurements taken in step 715. The location of the middle point may be determined according to a set of rules stored in a storage unit communicating with, embedded in or connected to the resistive touch apparatus.

In step 760, the location of the touch points is determined. The location may be determined according to estimations and a set of rules stored in a storage communicating with the resistive touch apparatus. In some exemplary cases, determining the location of the two touch points on the first resistive sheet is also a function of previously stored measurements. In such a case, the method further comprises a step of comparing the detected electronic attributes with the previously stored measurements in estimating the location of the touch points.

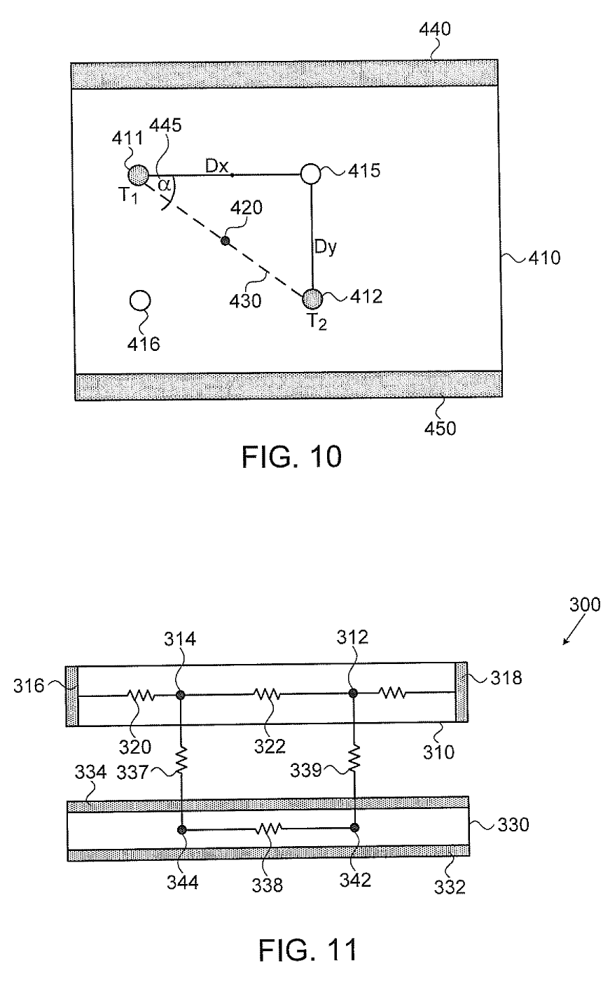

The method of the disclosed subject matter also provide for extracting coordinates of the touch points from the measurements described in FIGS. 2-5. In some exemplary cases, the coordinates of the touch points may be extracted from DX, DY, the range of angle 445 and the middle point 420 of FIG. 10. A fine-tuning correction can be applied on the extracted touch points coordinates based on their estimated locations and the angle 445.

In an exemplary embodiment of the disclosed subject matter, the location of the two touch points may be provided using a polynomial approximation method. In such a polynomial approximation method, the touch coordinates, the touch points intensity, and the resulting measured electrical attributes are inputted into a computerized unit that provides at least one polynomial expression that express the relation between the measurement and the touch points attributes. The said expressions get the measurements as input, and they output the touch point locations or other attributes such as DX, DY, the angle 445 and the middle point 420, in FIG. 10. The measured electrical attributes may be voltages, currents and/or resistance values detected in different and various touch locations and intensities. The computerized unit generates a model that takes into consideration the influence of each electrical attribute value of the two touch point locations and provides an approximation of the two touch point locations according to a vast amount of previously stored locations and associated electrical attribute values.

Persons skilled in the art will appreciate that the various steps described in detail in association with FIG. 7 can be performed in any order, which will achieve the objectives of the present subject matter.

FIG. 8 shows a method for determining a touch state on a first resistive sheet, according to some exemplary embodiments of the disclosed subject matter. In step 810, an electronic attribute representing the resistance value between the first and second resistive sheet, is detected and compared with a predefined threshold. If the detected value is not smaller than the predefined threshold, as shown in step 813, the touch state is determined to be a no-touch state. If the detected value is smaller than the predefined threshold, as shown in step 820, the resistance values between terminals representing sheet resistances across X-axis or Y-axis are compared with a corresponding threshold representing a single-touch state. In case both resistance values are higher than the threshold representing a single-touch state, as shown in step 822, the touch state is determined as a single-touch state. If the detected value is lower than the threshold representing a single-touch, as shown in step 830, it is determined whether the resistance value detected across one or more directions of the resistive sheet is smaller than a predefined or calibrated dual-touch threshold. If yes, as shown in step 835, the touch state is determined to be a non-detectable-touch state. If not, as shown in step 840, a correlation between the sheet resistance values and voltage measurement difference is determined. Such voltage difference may be the difference between two measurement setups of opposite edges, for example the difference between MS1 and MS2. Such a correlation may also take into account the inter-sheet resistance value. If there is a sufficient correlation, as shown in step 850, a dual touch-state is determined; otherwise, as shown in step 835, a non-detectable-touch state is detected.

FIG. 9 shows a lookup table that stores the results of a learning process of an electronic attribute, according to exemplary embodiments of the disclosed subject matter. The lookup table represents the relation between the sheet resistance measurements of FIG. 3, the inter-sheet resistance measurements of FIGS. 4 and 5 and DX. The values of the lookup table may be generated upon a set of measurements in which two fingers or stylus-type tools are placed on predefined locations along the X-axis of the first resistive sheet, at which the sheet resistance values and inter-sheet resistance values are evaluated. Similarly, another lookup table may relate to DY.

The measurement values in column 910 are proportional to the ratio between the sheet resistance value, as in MS5, and a serial resistor with a known value. The measurement values in columns 930 and 950 are proportional to the ratio between inter-sheet resistance values, as in MS7, MS8, MS9 and MS10, and a serial resistor with a known value. In the example, the measurement values of columns 930 and 950 represent the mathematical average between the two median values of the ratios between a serial resistor and the inter-sheet resistance values, as in MS7, MS8, MS9 and MS10. In some cases, more measurements can be used in conjunction with the above to get a more accurate estimation of DX.

The values in column 920 represent the corresponding DX for the measurement values in columns 910 and 930. The values in column 940 represent the corresponding DX for the measurement values in columns 910 and 950. The measurement values of columns 930 and 950 may depend on the distance between the touch points and on the intensity of the touch points.

During normal operation, the sheet resistance ratio and the inter-sheet resistance ratios are measured, as described above using a serial resistor. The sheet resistance ratio is matched to the corresponding line in column 910 and an interpolation can be used between two adjacent lines. Then, in a simplified case where the angle 445 is 0 degrees, the inter-sheet resistance ratio can be compared to the values at columns 930 and 950, and the distance on the X-axis is evaluated using a linear, non-linear or another type of interpolation. Note that a lookup table for the Y-axis can be applied in a similar way. In case where the angle 445 is different than 0 or 90 degrees, the best match between DX, DY the sheet resistance value in the X direction, the sheet resistance value in the Y direction and the inter-sheet resistance value which depend on the true distance between the touch points is found by an iterative search at which, the interpolation ratio between columns 930 and 950 should be the same for both X and Y lookup tables.

Other learning process tables can be prepared and used. For example, more touch intensities can be measured, or several tables similar to the one described in FIG. 9 can be prepared for different middle points 420 and for different angles 445. Such learning process tables may help to increase the detection accuracy.

FIG. 10 shows a first resistive sheet touched at two points, according to exemplary embodiments of the disclosed subject matter. The first resistive sheet 410 is touched at two points, first touch point 411 and second touch point 412. The first touch point 411 and the second touch point 412 may each be defined by both an X coordinate and a Y coordinate. A middle point 420 represents the average of X coordinates and Y coordinates of the first touch point 411 and the second touch point 412. The middle point 420 is positioned in the middle of an imaginary line, which represents a distance 430 connecting the first touch point 411 and second touch point 412. Shadow point 415 is represented by the X coordinate of the second touch point 412 and the Y coordinate of the first touch point 411. Shadow point 416 is represented by the Y coordinate of the second touch point 412 and the X coordinate of the first touch point 411.

In an exemplary embodiment of the disclosed subject matter, MS1, MS2, MS3 and MS4 are used for determining the location of the middle point 420. One way for determining the X location of middle point 420 is by applying mathematical average on MS1 and MS2. In a similar way, the Y location of the middle point can be found from MS3 and MS4. Another way to determine the X and Y locations of the middle point 420 is by a weighted average formula that gives more weight to the measurement setups on the terminals that are at a greater distance from the estimated middle point location. Below is an example of such weighted average formulas.

H_MID=(MS1*(MS2_MAX−MS2_AV)+MS2*(MS2_AV−MS2_MIN)/(MS2_MAX−MS2_MIN) 1.

V_MID=(MS3*(MS1_MAX−MS1_AV)+MS4*(MS1_AV−MS1_MIN)/(MS1_MAX−MS1_MIN) 2.

Where:

H_MID is the X coordinate of the middle point 420

V_MID is the Y coordinate of the middle point 420

MS1_AV is the mathematical average of MS1 and MS2

MS2_AV is the mathematical average of MS3 and MS4
MS1_MAX is the maximum possible value of MS1 or MS2.

MS2_MAX is the maximum possible value of MS213 or MS4.

MS1_MIN is the minimum possible value of MS1 or MS2.

MS2_MIN is the minimum possible value of MS3 or MS4.

The above-mentioned measurements can also be used to determine the angle formed between a virtual line that connects the two touch points, and the X-axis or the Y-axis of the first resistive sheet. In an exemplary embodiment of the disclosed subject matter, angle 445 is the angle between the imaginary line, which is represents distance 430 and the X-axis, below the X-axis as towards the positive values of the X-axis. In some cases, when MS1 is smaller than MS2, the angle 445 is between 90 and 180 degrees; otherwise, the angle 445 is between 0 and 90 degrees. Determining the angle 445 enables distinguishing between the first touch point 411 and the second touch point 412 and the shadow points 415 and 416. In some cases, the difference between MS1 and MS2 increases as the distance between the first touch point 411 and the second touch point 412 increases, as the angle 445 become closer to either 45 degrees or 135 degrees, or as the touch intensity increases. As a result, given the estimation of the touch intensity and either DX or DY, the DX (if DY was given) or DY (if DX was given) can be estimated, for example, according to the following formulas:

DX=(MS1−MS2+MS3−MS4)*KX/(I*DY)

DY=(MS1−MS2+MS3−MS4)*KY/(I*DX)

Where KX and KY are constants determined to convert the ADC units to centimeters; is a factor extracted from the touch intensity, which is in turn extracted from the inter-sheet resistance measurements.

FIG. 11 shows a schematic structure of a resistive touch apparatus, according to exemplary embodiments of the disclosed subject matter. Resistive touch apparatus 300 comprises a first resistive sheet 310 and a second resistive sheet 330. The surface of the second resistive sheet 330 is in proximity or substantially parallel to the surface of the first resistive sheet 310. The first resistive sheet 310 is connected to terminals 316, 318. The second resistive sheet 330 is connected to terminals 332, 334.

When pressure is applied to the first resistive sheet, the first resistive sheet 310 is pressed against the second resistive sheet 330 at two touch points. A touch point 314 of the first resistive sheet 310 is in contact with a touch point 344 of the second resistive sheet 330, and the touch point 312 of the first resistive sheet 310 is in contact with the touch point 342 of the second resistive sheet 330. When the touch point 312 is in contact with touch point 342 and when touch point 314 is in contact with touch point 344 electrical current flows from the first resistive sheet 310 to the second resistive sheet 330. Resistors 337 and 339 model the connections between the second resistive sheet 330 and the first resistive sheet 310 through the touch points 312, 342, 344 and 314. Resistor 338 models the equivalent resistance value between the touch point 342 and the touch point 344 on the second resistive sheet 330. Although this is a simplified model, it can be seen that the accumulating resistance value of the resistors 337, 338 and 339 resides in parallel to the resistor 322, which models part of the resistance of the first resistive sheet 310. Therefore, the equivalent resistance value between the terminals 316, 318 is reduced due to the presence of resistors 337, 338 and 339.

The resistance value between the terminals 316, 318 of the first resistive sheet 310 when touched at the touch points 312, 314 is mainly a function of the distance between the touch points 312, 314 and the touch intensity at those touch points. Evaluation of touch intensity may be performed by evaluating the resistance value between the first and second resistive sheets.

The flowchart and block diagrams in the figures illustrate the architecture, functionality, and operation of possible implementations of systems, methods and computer program products according to various embodiments of the present subject matter. In this regard, each block in the flowchart or block diagrams may represent a module, segment, or portion of program code, which comprises one or more executable instructions for implementing the specified logical function(s). It should also be noted that in some embodiment implementations, the functions noted in the block may occur not in the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by to special purpose hardware-based systems that perform the specified functions or acts, or combinations of special purpose hardware and computer instructions.

The terminology used herein is for the purpose of describing particular embodiments only and is not intended to be limiting of the subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the disclosed subject matter may be embodied as a system, method or computer program product. Accordingly, the disclosed subject matter may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present subject matter may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for example, optically scanning the paper or other medium; then compiling, interpreting, or otherwise processing it in a suitable manner, if necessary; and then storing it in computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, and the like.

Computer program code for carrying out operations of the present subject matter may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or steps, plus function elements in the claims below, are intended to include any structure, material, or act for performing the function in combination with other claimed elements, as specifically claimed. The description of the present subject matter has been presented for purposes of illustration and description, but is not intended to be exhaustive or limited to the subject matter in the form disclosed. Many modifications and variations will be apparent to those of ordinary skill in the art without departing from the scope and spirit of the subject matter. The embodiment was chosen and described in order to best explain the principles of the subject matter and the practical application and to enable others of ordinary skill in the art to understand the subject matter for various embodiments with various modifications as are suited to the particular use contemplated.

While the disclosure has been described with reference to exemplary embodiments, it will be understood by those skilled in the art that various changes may be made and equivalents may be substituted for elements thereof without departing from the scope of the subject matter. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this subject matter, but only by the claims that follow.

1. An apparatus, comprising:
a first resistive sheet;
a second resistive sheet, the second resistive sheet is disposed in proximity to the first resistive sheet, such that pressure applied at a first touch point and at a second touch point on the first resistive sheet causes flow of electrical current between the first resistive sheet and the second resistive sheet;
a control unit coupled to a first terminal and to a second terminal, and configured to measure a first resistance between the first terminal and the second terminal; and
configured to estimate a distance between the first touch point and the second touch point.

2. The apparatus of claim 1, wherein the first terminal and the second terminal are coupled to the first resistive sheet.

3. The apparatus of claim 1, wherein the first terminal and the second terminal are coupled to the second resistive sheet.

4. The apparatus of claim 1, wherein the control unit is further configured to measure a second resistance between the first terminal and the second terminal, the first terminal is coupled to the first resistive sheet and the second terminal is coupled to the second resistive sheet.

5. The apparatus of claim 1, wherein the control unit is further configured to measure a voltage at the first terminal and at the second terminal; and wherein the control unit is further configured to estimate a location of the first touch point and the second touch point.

6. The apparatus of claim 1, further comprises a storage device configured to store a look up table associating measured electronic attributes and data related to the distance between the first touch point and the second touch point.

7. A method for estimating a distance between a first touch point and a second touch point on a resistive sheet, the method comprising:
measuring a first resistance value between two terminals connected to the resistive sheet selected from a group consisting of a first resistive sheet and a second resistive sheet; and
estimating the distance between the first touch point and the second touch point based on the resistance value.

8. The method according to claim 7 wherein the resistance value is in at least one direction.

9. The method according to claim 7, further comprises a step of performing a learning process of the first resistive sheet and the second resistive sheet.

10. The method according to claim 7, further comprises a step of determining that the first resistive sheet is in contact at the first touch point and the second touch point.

11. The method according to claim 7, further comprises a step of measuring a voltage at a first terminal and at the second terminal and further comprising a step of estimating a location of the first touch point and of the second touch point on the resistive sheet based on the resistance value and the voltage.

12. The method according to claim 11, further comprises a step of determining a location of a middle point representing an average of X coordinates and Y coordinates of the first touch point and of the second touch point.

13. The method according to claim 11, wherein estimating the location of the first touch point and of the second touch point comprises a step of converting at least one measured resistance value into the distance using a look-up table.

14. The method according to claim 7, wherein the estimation of the distance between the first touch point and the second touch point is based on polynomial approximation.

15. The method according to claim 11, wherein the estimation of the location of the first touch point and of the second touch point on the resistive sheet is based on polynomial approximation.

16. The method according to claim 11, further comprises a step of measuring a second resistance between the first terminal and the second terminal, the first terminal is coupled to the first resistive sheet and the second terminal is coupled to the second resistive sheet.
